(19) United States
(12) Patent Application Publication
(10) Pub. No.: US 2016/0135646 A1
(43) Pub. Date: May 19, 2016

(54) BURR GRINDER STABILIZATION APPARATUS AND SYSTEM

(71) Applicants: Alejandro Cacciamani, Miami, FL (US); Andres Fernandez, Miami, FL (US)

(72) Inventors: Alejandro Cacciamani, Miami, FL (US); Andres Fernandez, Miami, FL (US)

(21) Appl. No.: 14/939,198

(22) Filed: Nov. 12, 2015

Related U.S. Application Data
(60) Provisional application No. 62/081,310, filed on Nov. 18, 2014.

(51) Int. Cl. A47J 42/04; A47J 42/40

(52) U.S. Cl. CPC A47J 42/04; A47J 42/40

(57) ABSTRACT

The present invention is a grinding apparatus that has two bearings or rotational supports attached to the central shaft, as opposed to one bearing or rotational support, for added stability and consistency in grain size during grinding. The core components of the invention are a shaft, an upper bearing or rotational support, an inner grinding burr, an outer grinding burr, a lower bearing or rotational support, and a stabilizing cage. These components are configured as follows: the shaft is axially in contact to an upper bearing or rotational support, and an inner grinding burr is attached axially to the shaft and underneath the upper bearing or rotational support; a lower bearing or rotational support is axially in contact to said shaft and underneath the inner grinding burr; and a stabilizing cage is in contact to the exterior of the lower bearing and holds the bearing in place with respect to the exterior housing of the grinder. The invention can be used to provide much more consistent grain size when grinding substances which is necessary in certain applications; notably, applications in the culinary arts. Furthermore, the removable aspect of the stabilizing cage facilitates the user's removal of this component for cleaning of the grinder apparatus.

### CROSS-REFERENCE TO RELATED APPLICATIONS

This non-provisional patent application claims the benefit of the currently pending U.S. Provisional Patent Application No. 62/081,310, filed on 18 Nov., 2014, which is incorporated by reference as if fully set forth herein.

### STATEMENT REGARDING FEDERALLY SPONSORED-RESEARCH OR DEVELOPMENT

None.

### FIELD OF THE INVENTION

The invention relates generally to the field of stabilization apparatuses, and more particularly, to a burr grinder system with an integrated stabilization apparatus.

### BACKGROUND

Grinders have a diverse array of application. Grinders are used, for example, in the culinary field where they are used to grind seeds, coffee beans, and spices among other food substances. Most of these culinary grinders use an inner and outer burr in a tight configuration so as to grind larger grains of food substances into smaller grains of the same substance. It is known in the art for burr grinders to use a central shaft connected to a conical burr that functions similar to a mill when turned by a handle. This central shaft may be rotably fixed on a first distal end to a bearing. In most instances, the central shaft is held in place within an opening made in a supporting member and without the use of a bearing. The use of a bearing, or lack thereof, has nominal effect as the frictional forces between the rotating shaft and the supporting member is nominal. The second distal end is attached to a conically shaped inner burr. There is no other form of rotational support that keeps the axis of the central shaft in a fixed position so the central shaft is essentially rotably coupled on one end and freely dangles from the single bearing. Currently in the prior art, burr grinders cannot have any rotational support to keep the second distal end of the central shaft in a rotably fixed position because such a modification would not allow for adjusting the burrs for different grain size. Many embodiments in the art do not include anything that stabilizes this central shaft, or the burr that is attached to it, in order to achieve a consistent grind size. Because the burr does not remain stable, it wobbles during grinding, thus yielding diversely sized grains.

The size of the grain is in direct correlation to the distance between the two burrs; therefore a larger space between the burrs results in larger grain size while a tighter space results in smaller grain size. Wobbling, or fluctuation in the space between the burrs, during grinding results in the creation of uneven grain sizes, which is undesired in many grinding applications. An example of such application is in the grinding of coffee beans for the brewing of coffee, where large deviations in the grain size of ground coffee beans is unfavorable for the brewing of certain types of coffee. It is therefore important in such applications that the tolerance in the distance between the burrs be minute to achieve a consistent grain size in the material being grinded.

Some solutions in the art have attempted to address the problem addressed above by providing an addition or modification to the existing grinder with which the inner burr is better stabilized. This addition takes the form of an additional supported-bearing which is attached to another point on the shaft that holds the inner burr. However, this modification falls short of minimizing tolerance in the distance between the burrs due to the geometry of the additional element and the restrictive space within the grinder. Furthermore, existing modifications are not easily removable for cleaning.

It would, therefore, be desirable to have a stabilizing apparatus integrated for such grinders that minimizes the tolerance in the distance between the burrs while being easily removable for cleaning purposes.

Additionally, it would be desirable to have a burr grinder system with an integrated stabilizing apparatus that minimizes the tolerance in the distance between the burrs of said burr grinder system.

It would also be desirable to have an improved burr grinder utilizing an integrated stabilizing apparatus so as to minimize the tolerance in the distance between the burrs of the grinder.

Moreover, it would be desirable to have a grinder apparatus modification kit that can be fitted to an existing grinder for the purpose of improving its function by introducing a stabilizing apparatus into its grinding system and minimizing the tolerance in the distance between the burrs of the grinder.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### SUMMARY

An embodiment of the present invention is directed to an apparatus that satisfies the need for a better stabilized grinder by incorporating a stabilizing apparatus. This embodiment comprises two or more bearings; at least one bearing or rotational support on a first distal end of a shaft and at least one bearing or rotational support on a second distal end of said shaft. These additions keep the central shaft from wobbling and therefore create a much more consistent grind size during grinding. Moreover, the bearings also steady the handle when it is being rotated by the user.

Another embodiment of the invention is a stabilizing system, embodiments thereof providing for a complete grinding system, comprising the following components: an upper housing, which is shaped to hold the substance to be ground; a shaft, which has an upper and lower distal end; a nut; a handle; a locking ring; an adjustment ring; an upper bearing or other form of rotational support; an inner grinding burr; an outer grinding burr; a lower bearing or other form of rotational support; a stabilizing cage; a slotted ring; and a lower housing, which is shaped to catch the ground substance. These components are related as follows: the shaft extends through the center of the upper housing; the nut is screwed axially onto said shaft on a distal upper end; the handle is attached axially to the shaft and underneath the nut; the locking ring is attached axially to the shaft and underneath the handle; the adjustment ring is attached axially between the shaft and the upper housing, and located underneath the locking ring; the upper bearing's interior bearing surface is attached axially to the shaft, the upper bearing's exterior bearing surface is attached to the upper housing, and the upper bearing is located underneath the adjustment ring; the inner grinding burr is attached axially to the shaft and underneath the upper bearing; the outer grinding burr is axially aligned and concentric to the inner grinding burr and is attached to the upper housing; the lower bearing is attached axially to the shaft and underneath the inner grinding burr; the stabilizing cage is attached to the exterior of the lower bearing and to the slotted ring; the slotted ring is mechanically fixed to the upper housing; and the lower housing is coupled to the bottom of the upper housing.

A further embodiment discloses an improvement upon an existing burr grinder, embodiments thereof provide for a complete grinding system comprising the following components: an elongated shaft; an upper bearing or other rotational support, attached axially to said elongated shaft, on a first distal end; an inner grinding burr, attached axially to said shaft and underneath said upper bearing; a lower bearing or other rotational support, attached axially and on second distal end of said elongated shaft and underneath said inner grinding burr; a stabilizing cage, attached to the exterior bearing surface of said lower bearing. Importantly, the elongated shaft extends substantially beyond the inner grinding burr and extends until it makes contact with the interior bearing surface of said lower bearing.

A further embodiment discloses a stabilizing apparatus, embodiments thereof provide for a removable stabilizing mechanism, which is comprised of the following components: a slotted ring component, including a central axis aligned to the burr shaft of a grinder, geometric features which allow for the attachment of a stabilizing cage, and circumference is substantially in contact with housing of the grinder fixed directly to the interior of the grinder; a stabilizing cage, sharing a central axis with the support component and with geometric features that allow it to be attached and detached by the user from the support component without the use of tools; and a bearing or other rotational support, fixed in the geometric center of the bearing holder and joining the bearing holder to the burr shaft of the grinder. These components are related as follows: The support component is fixed to the body of the grinder and sits around the outer burr. The stabilizing cage is coupled to the support component via the geometric features that allow it to be readily attached and detached by the user. This stabilizing cage houses the bearing which sits in the lower center of the bearing holder and is axially aligned with the shaft that holds the lower burr.

Certain embodiments of the present invention may be used for, but not limited to, the grinding of coffee, spices, condiments, mixtures of spices and/or condiments, wheat grain, other food substances. It is contemplated, however, that the use of certain embodiments of the present invention in other applications beyond culinary use, is within the scope of the present invention. For example, the grinder system may be used for grinding construction materials, stones, glass, waste materials, plastics, and the like.

Embodiments of the present invention may include components manufactured from various materials based upon the contemplated use. The burrs may be made from metals such as steel or stainless steel, from stone, ceramics, or carbides. Other components may be made of metals such as steel, stainless steel, aluminum, or from plastics such as nylon or ABS. It is also contemplated that food-grade materials may be used in the manufacture of one or more components.

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a front view in accordance with an embodiment of the present invention showing a manual hand-held grinder with both upper housing subassembly and lower housing attached together.

FIG. 2 is a composite of two orthographic projection views, FIG. 2A and FIG. 2B in accordance with an embodiment of the present invention showing an upper housing subassembly.

FIG. 3 is an exploded perspective view in accordance with an embodiment of the present invention showing various components comprising an upper housing subassembly.

FIG. 4 is a composite of various orthographic projection views, FIGS. 4A, 4B, 4C and 4D, in accordance with an embodiment of the present invention showing a locking ring.

FIG. 5 is a top view in accordance with an embodiment of the present invention showing an adjustment ring.

FIG. 6 is a front view in accordance with an embodiment of the present invention showing a shaft and inner grinding burr subassembly.

FIG. 7 is a composite of two orthographic projection views in accordance with an embodiment of the present invention showing an upper housing, upper bearing, and outer grinding burr subassembly.

FIG. 8 is a composite of two orthographic projection views in accordance with an embodiment of the present invention showing a slotted ring.

FIG. 9 is a composite of various orthographic projection views in accordance with an embodiment of the present invention showing a lower bearing and stabilizing cage subassembly.

FIG. 10 is an exploded cross-sectional view in accordance with an embodiment of the present invention showing an upper housing subassembly.

FIG. 11 is a cross-sectional view in accordance with an embodiment of the present invention showing an upper housing subassembly.

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or van contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “mechanical features” is used herein to mean features of a component, mechanical or geometric, which have a functional purpose of attaching or linking that component to one or more other components with compatible or corresponding mechanical features. An example of a mechanical feature is a slot in a component, where said slot is designed to accept a tab from another component and the union of the slot and tab from the two components effectively links, attaches, fixes, and/or locks the components together. The term “mechanical features” refers to, but is not limited to: hooks, hook and loop fasteners, slot and tabs, all male and female fasteners, screws, bolts, nuts, holes that have been tapped, latches, pins, etc.

The term “bearing” or “rotational support” is used herein to mean a mechanically functional feature with the purpose of retaining a shaft in place while leaving it free to rotate along its axis. The effect of using such a feature results in a shaft, with a rotational axis, that is able to freely rotate around its axis and translate along this axis, but not able to make any other form of motion. Not only is this term inclusive of commonly-known bearings, but also includes geometric features, such as slots or openings of larger diameter than a shaft, which allow the shaft to freely rotate in place. Therefore, this feature may not only come in the form of a separate hardware component, but may also be built into the components surrounding the shaft.

While the specification will conclude with claims defining the features of embodiments of the invention that are regarded as novel, it is believed that the invention will be better understood from a consideration of the following description in conjunction with the figures, in which like reference numerals are carried forward.

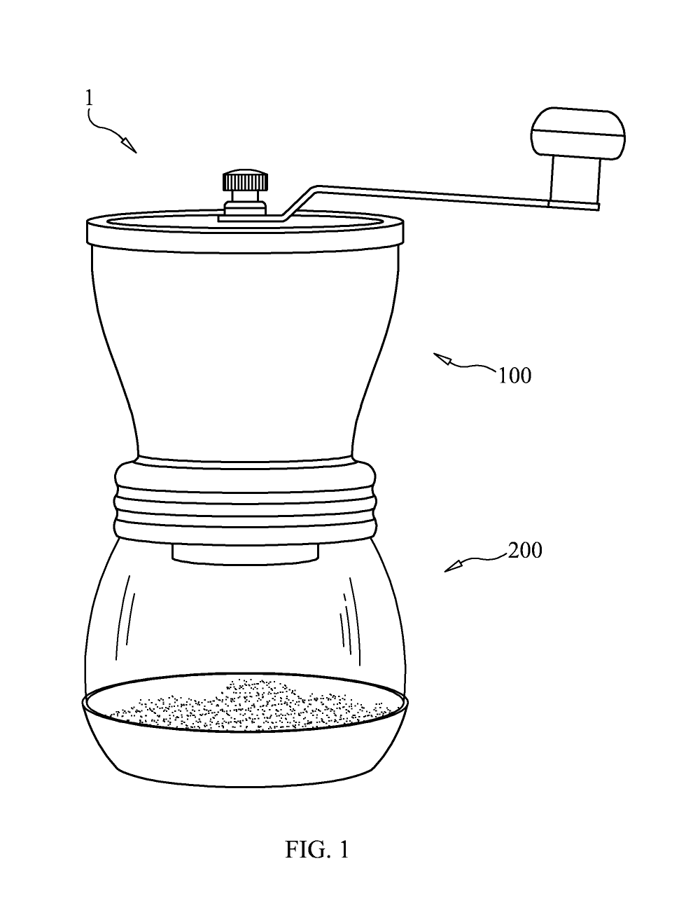

Referring to FIG. 1, a preferred embodiment of the present invention is in the form of a manual coffee grinder with an upper housing subassembly 100 and lower housing 200. The upper housing subassembly 100 is positioned relative to the lower housing 200 in such a manner that the lower housing 200 is capable of collecting the ground substance from the upper housing subassembly 100.

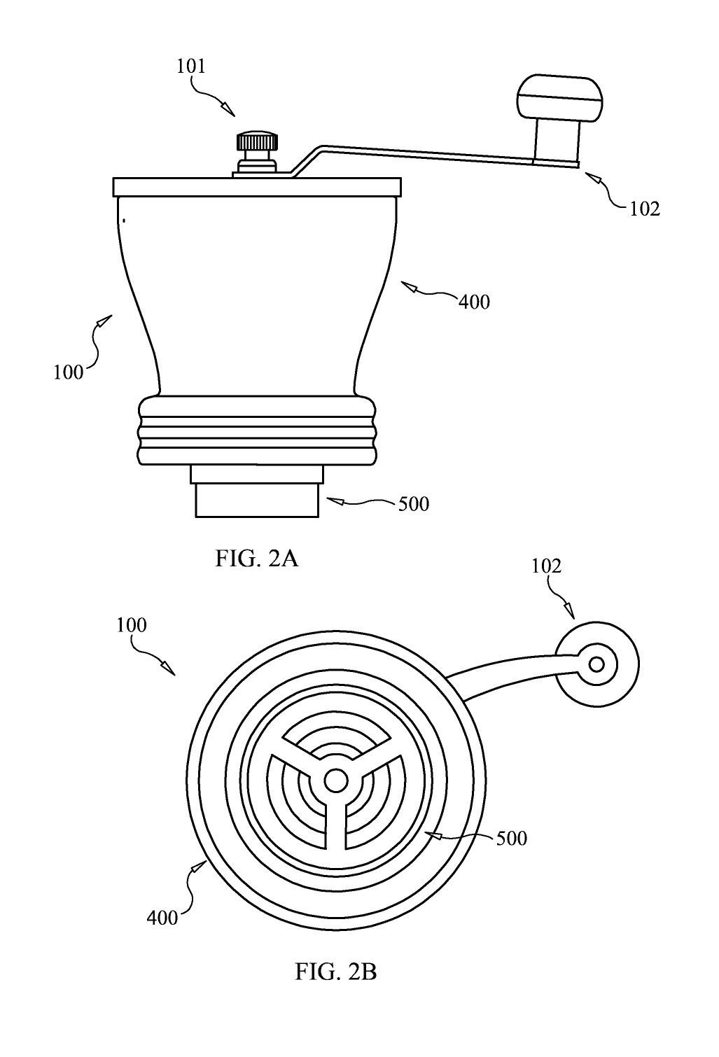

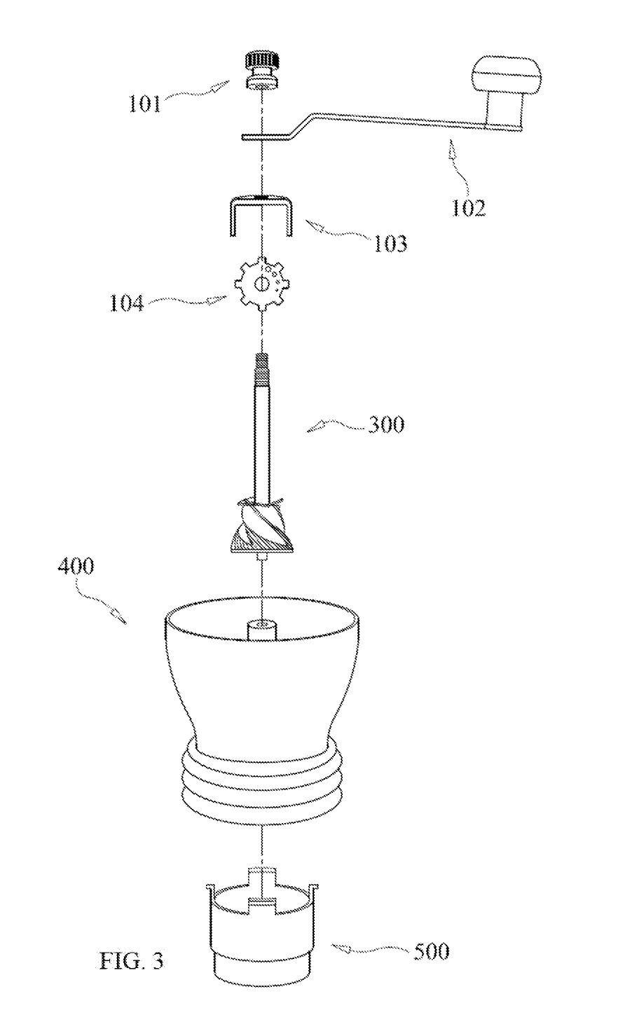

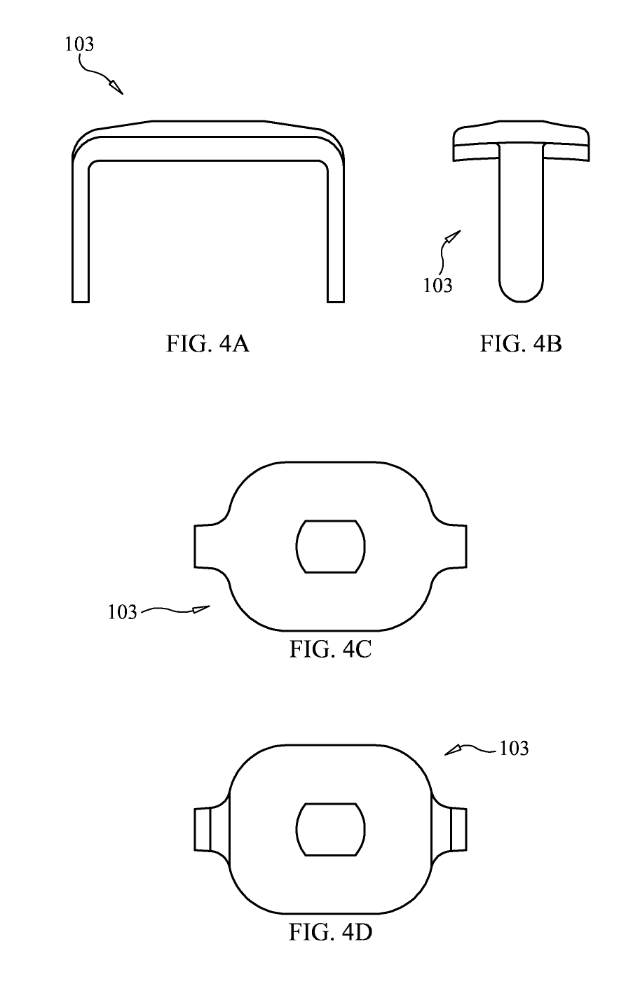

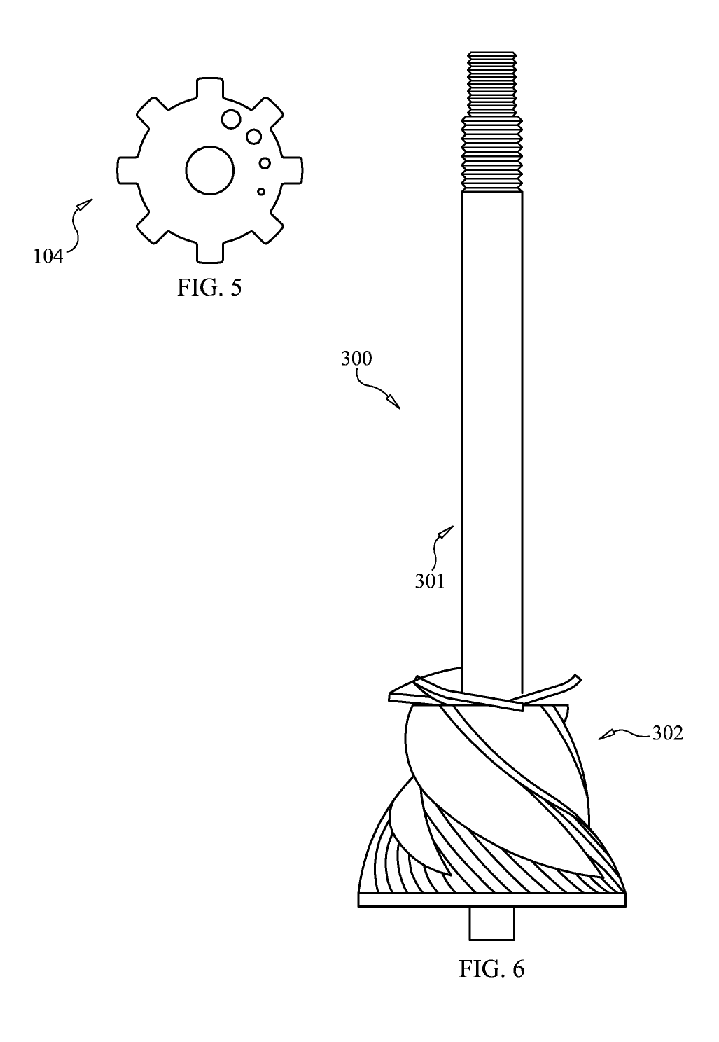

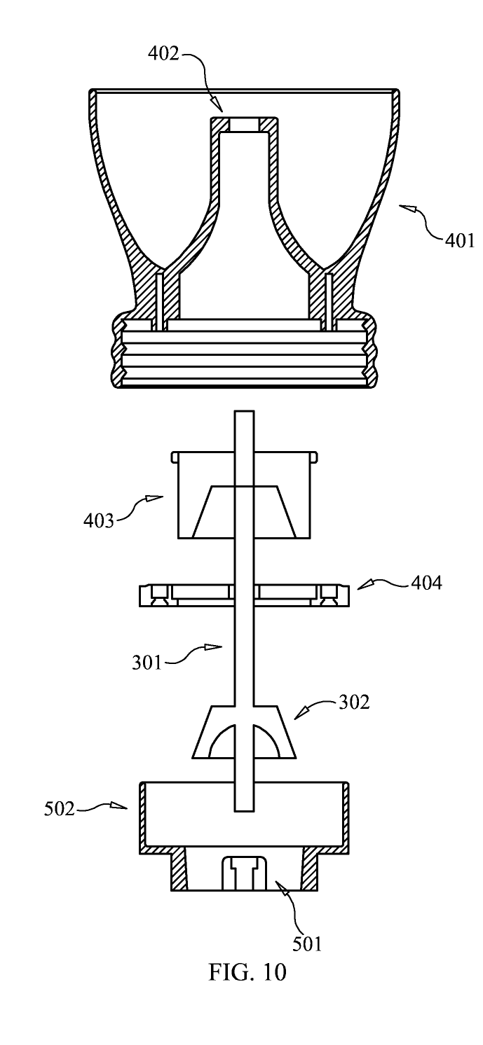

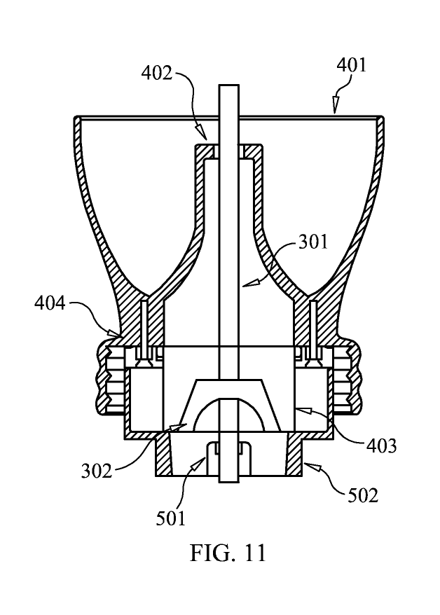

Referring to FIGS. 2, 3, 4, 5, 6, 7, 8, 9, 10 and 11 generally, a preferred embodiment of the upper housing subassembly 100 is made up of the following components: an upper housing 401, shaped to hold the substance to be ground; a shaft 301, which extends vertically through the center of the upper housing 401; a nut 101, which is screwed axially onto the shaft 301 on an upper distal end; a handle 102, which is attached axially to the shaft 301 and underneath the nut 101; a locking ring 103, attached axially to the shaft 301 and underneath the handle 102; an adjustment ring 104, attached axially between the shaft 301 and the upper housing 401, and located underneath the locking ring 103; an upper bearing 402, in between the shaft 301 and the upper housing 401 and underneath the adjustment ring 104; an inner grinding burr 302, attached axially to the shaft 301 and underneath the upper bearing 402; an outer grinding burr 403, axially aligned and concentric to the inner grinding burr 302 and attached to the upper housing 401; a lower bearing 501, attached axially to the lower distal end of the shaft 301 and underneath the inner grinding burr 302; a stabilizing cage 502 with tabs 503, a lower bearing 501 in between the stabilizing cage 502 and shaft 301 and attached to a slotted ring 404 by way of inserting tabs 503 into slots 405; said slotted ring 404 is fixed to the upper housing 401.

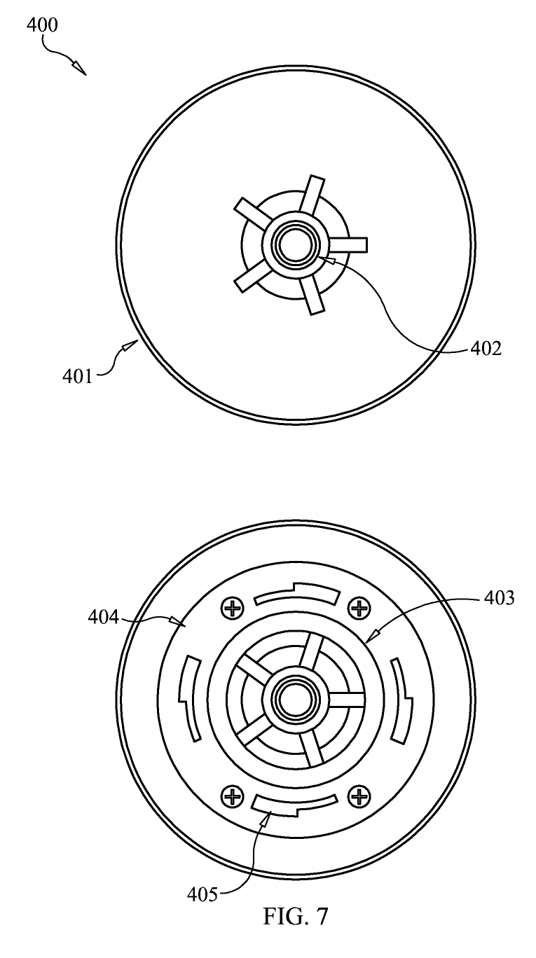

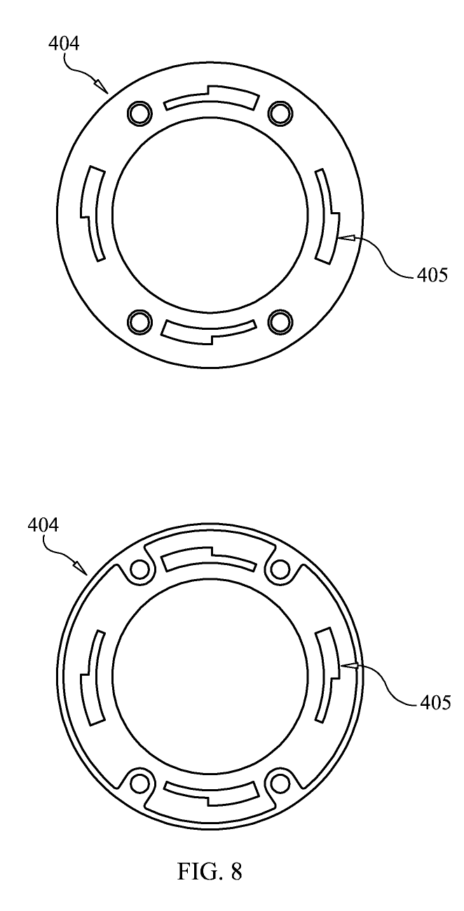

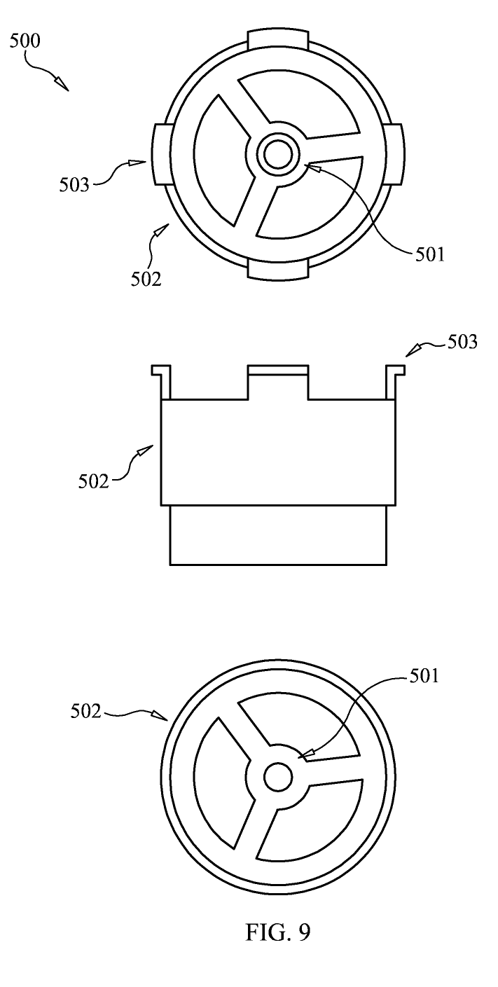

For illustrative purposes, several components are grouped into subassemblies within upper housing subassembly 100; namely, subassembly 300 as seen in FIG. 6, which comprises the shaft 301 and inner grinding burr 302; subassembly 400 as seen in FIG. 7, which comprises the upper housing 401, upper bearing 402, outer grinding burr 403, and slotted ring 404; and subassembly 500 as seen in FIG. 9, which comprises the lower bearing 501 and stabilizing cage 502. Note that, in FIG. 9, the lower bearing 501 is not shown as a bearing component, but rather as a rotational support.

In an alternative embodiment, wherein the grinder does not have to be manual, the upper housing subassembly 100 would comprise the following components: an upper housing 401, shaped to hold the substance to be ground; a shaft 301, which extends through the center of the upper housing 401; an upper bearing 402, positioned between the shaft 301 and the upper housing 401; an inner grinding burr 302, attached axially to the shaft 301 and underneath the upper bearing 402; an outer grinding burr 403, axially aligned and concentric to the inner grinding burr 302 and attached to the upper housing 401; a stabilizing cage 502, attached to the upper housing 401; and a lower bearing 501, positioned between the shaft 301 and the stabilizing cage 502.

It is contemplated that the upper housing 401 may include slots similar to slots 405 so as to accept the tabs 503 from the stabilizing cage 502. By doing so, the need for using a separate component, slotted ring 404, is extinguished. This concept of eliminating the slotted ring 404 component may be applied to any of the disclosed embodiments proffered by Applicant.

It is further contemplated that the stabilizing cage 502 may be fixed permanently to the upper housing 401 or be made an integrated design feature of said upper housing 401. By doing so, the need for using a separate component, slotted ring 404, is again extinguished. This concept of integrating the slotted ring 404 component into the design of the upper housing 401 may be applied to any of the disclosed embodiments proffered by Applicant.

It is further contemplated that bearings 402 and 501 may be replaced with mechanically functional equivalents. Therefore Applicant anticipates the use of different types of bearings, or the lack thereof, such as with the use of components made of frictionless or self-lubricating materials. The latter embodiment would be realized if such frictionless or self-lubricating materials were used in the manufacture of shaft 301 and/or stabilizing cage 502.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. A grinder modifying kit comprising:
a shaft;
a slotted ring, configured to be attached to an upper housing of a grinder and having mechanical features that allow for the attachment of a stabilizing cage;
a stabilizing cage, sharing a central axis with said slotted ring and with mechanical features configured to be attached and detached by the user from said slotted ring; and
a lower bearing or rotational support, positioned between said shaft and said stabilizing cage.

2. A grinding apparatus comprising:
an upper housing, shaped to hold a substance to be ground;
a shaft, which extends through the center of said upper housing;
an upper bearing or rotational support, positioned between said shaft and said upper housing;
an inner grinding burr, attached axially to said shaft and underneath said upper bearing;
an outer grinding burr, axially aligned and concentric to said inner grinding burr, attached to said upper housing;
a stabilizing cage, sharing a central axis with said upper housing and with mechanical features that allow it to be attached and detached by the user from said upper housing; and
a lower bearing or rotational support, positioned between said shaft and said stabilizing cage.

3. The grinding apparatus of claim 2, further comprising:
a locking ring, attached axially to a first distal end of said shaft;
an adjustment ring, attached axially to said shaft, and located underneath said locking ring;

4. The grinding apparatus of claim 3, further comprising:
a lower housing, coupled to said upper housing and shaped to catch the ground substance.

5. A grinding apparatus comprising:
an upper housing, shaped to hold a substance to be ground;
a shaft, which extends through the center of said upper housing;
an upper bearing or rotational support, positioned between said shaft and said upper housing;
an inner grinding burr, attached axially to said shaft and underneath said upper bearing;
an outer grinding burr, axially aligned and concentric to said inner grinding burr, attached to said upper housing;
a slotted ring, sharing a central axis with said upper housing, attached to said upper housing, and having mechanical features that allow for the attachment of a stabilizing cage; and
a stabilizing cage, sharing a central axis with said slotted ring and with mechanical features configured to be attached and detached by the user from said slotted ring; and
a lower bearing, positioned between said shaft and said stabilizing cage.

6. The grinding apparatus of claim 5, further comprising:
a locking ring, attached axially to a first distal end of said shaft;
an adjustment ring, attached axially to said shaft, and located underneath said locking ring;

7. The grinding apparatus of claim 6, further comprising:
a lower housing, coupled to said upper housing and shaped to catch the ground substance.
